(19) United States
(12) Patent Application Publication
(10) Pub. No.: US 2001/0047609 A1
(43) Pub. Date: Dec. 6, 2001

(54) Fishing lure

(76) Inventors: Eric P. Orgeron, River Ridge, LA (US); Glenn Dowell SR., Gretna, LA (US)

Correspondence Address: GARVEY SMITH NEHRBASS & DOODY, LLC, THREE LAKEWAY CENTER, 3838 NORTH CAUSEWAY BLVD., SUITE 3290, METAIRIE, LA, 70002

(21) Appl. No.: 09/779,169

(22) Filed: Feb. 8, 2001

Related U.S. Application Data
(60) Provisional application No. 60/180,922, filed on Feb. 8, 2000.

(51) Int. Cl. A01K 85/00

(52) U.S. Cl. 43/42.31

(57) ABSTRACT

An improved fishing lure which can be used for imitating the sight, sound and natural movements of a live bait, and preferably a live shrimp.

### CROSS-REFERENCE TO RELATED APPLICATIONS

Priority of U.S. Provisional Patent Application Ser. No. 60/180,922, filed Feb. 8, 2000, incorporated herein by reference, is hereby claimed.

### STATEMENT REGARDING FEDERALLY SPONSORED RESEARCH OR DEVELOPMENT

Not applicable

### REFERENCE TO A “MICROFICHE APPENDIX”

Not applicable

### BACKGROUND OF THE INVENTION

1. Field of the Invention

The present invention relates to a fishing lure and more particularly pertains to imitating the natural sight and movements of a live shrimp, squid, crawfish or other fishing bait within the scope of the invention.

2. General Background of the Invention

Fishing lures heretofore devised and utilized for the purpose of attracting fish are known to consist basically of familiar, expected and obvious structural configurations and a myriad of designs encompassed by the crowded prior art which have been developed to meet countless objectives and requirements. By way of example, U.S. Pat. No. 5,787,634 discloses an action lure designed to simulate the movements of a live shrimp. While this and other devices fulfill their respective and particular objectives and requirements, the aforementioned patent does not describe a lure that simulates the sight, sound and movement of live bait without the physical operation of said lures by the fisherman. Therefore, it can be appreciated that there exists a continuing need for a new and improved fishing lure which can be used for imitating the sight, sound and natural movements of a live bait.

The following U.S. Patents are incorporated herein by reference:

U.S. Pat. Nos. 5,787,634; 5,934,008; and 6,009,658.

### BRIEF SUMMARY OF THE INVENTION

The present invention substantially fulfills the need for a new and improved fishing lure which can be used for imitating the sight, sound and natural movements of a live bait. The apparatus of the present invention is an improved fishing lure which can be used for imitating the sight, sound and natural movements of a live bait.

The living lure according to the present invention substantially departs from the conventional concepts and designs of the prior art and in doing so provides an apparatus primarily developed for the purpose of imitating the sight, sound and natural movement of a living bait without the need for teaching and/or experience in the art of fishing.

### BRIEF DESCRIPTION OF THE SEVERAL VIEWS OF THE DRAWINGS

For a further understanding of the nature, objects, and advantages of the present invention, reference should be had to the following detailed description, read in conjunction with the following drawings, wherein like reference numerals denote like elements and wherein:

FIG. 1 is a side, perspective view of a fishing lure of the preferred embodiment of the present invention in an open position;

FIG. 2 is a top view of the fishing lure of the preferred embodiment of the present invention in the open position;

FIG. 3 is a side, perspective view of the fishing lure of the preferred embodiment of the present invention in a closed position;

FIG. 4 is a perspective view of a second embodiment of a fishing lure of the present invention;

FIG. 5 is a side, perspective view of the fishing lure of a third embodiment of the present invention in an open position;

FIG. 6 is a side, perspective view of the fishing lure of the third embodiment of the present invention in a closed position;

FIG. 7 is a side, perspective view of the fishing lure of a fourth embodiment of the present invention in an open position;

FIG. 8 is a side, perspective view of the fishing lure of a fifth embodiment of the present invention;

FIG. 9 is a side, perspective view of the fishing lure of a sixth embodiment of the present invention; and

FIG. 10 is a top view of the fishing lure of a seventh embodiment of the present invention in an open position.

### DETAILED DESCRIPTION OF THE INVENTION

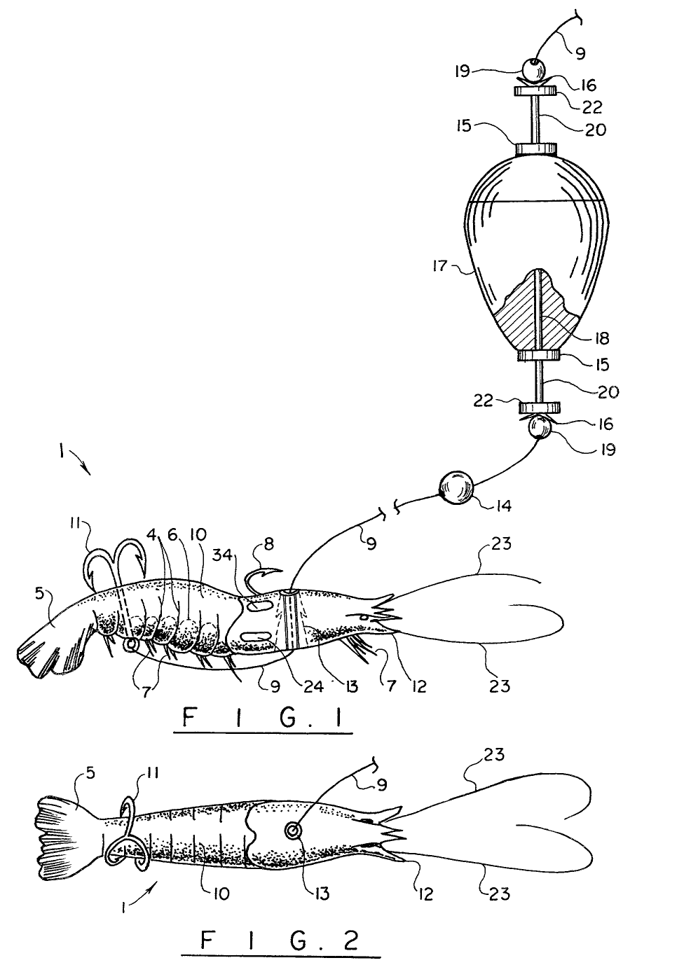

In the view of the foregoing disadvantages inherent in the known types of fishing lures now present in the prior art, the present invention provides an improved fishing lure. As such, the general purpose of the present invention, which will be described subsequently in greater detail is to provide a new and improved fishing lure and method which has all the advantages of the prior art and none of the disadvantages. To attain this, the apparatus of the preferred embodiment of the present invention, designated generally in FIG. 1 by the numeral 1, essentially comprises a body 10 made of a flexible plastic type material, i.e., flexible plastisol.

The flexible plastic body 10 may be molded or injection molded of preferably moldable plastic or rubber, e.g., various hardness plastisol, i.e. 10, 15, 20 or 30 Shore A hardness so as to create varying degrees of tail section movement by allowing the difference in hardness of the said plastisol material to perform or act as a springback mechanism after the fishing line or leader 9 has been actuated or pulled by either the movement of the fishing cork 17 and/or the action of the users line.

The flexible body section 10 may also have grooves or cavities 6 in the underside of the body section 10 at different points so as to simulate the effects of a hinge at said point to further enhance the ease of said tail movement caused by wave action and/or the movement of said cork 17 or the movement of the users fishing rod.

It is another object of the invention to put cuts 4 into the top portion of the said lure to further accentuate the flexibility of said lure body 10 so as to fine tune the lure's movement in the water. This construction also allows for the use of harder durometer flexible body material to allow for stronger protruding pieces such as legs and tentacles 7 to further simulate a natural bait action and/or appearance.

The body section 10 may or may not have protruding parts such as the forward fins 12 of a shrimp that extend outwardly from the head section at equal angles so as to create a balancing hydrodynamic effect that stabilizes or keeps the head section level during the lure's up and down movement caused by the actuation of the tail section 5 by the line or leader 9 through the insert 13.

The head section of the body 10 has a weighted or nonweighted insert 13 that has a hole or bore through the said insert 13 to create a tube or tube means so that the fishing leader line 9 may pass through the insert 13 to act as a guide to allow the fishing line or leader's movement to pull and/or jerk the tail section 5 to create the natural pull back motion of a living or natural bait. This bore can be inclined relative to the direction of travel of the bait as shown in FIG. 1.

The weighted pass-through insert 13 is made of a lead type non-ferrous metal material or the like and acts as a counter balancing weight to help keep the lure body 10 at a level position while hanging on the fishing line or leader 9.

A nonweighted pass through insert 13 can be made of a plastic type material, i.e. rigid PVC, HDPE, etc. Both the weighted and nonweighted insert 13 have a cylindrical shape but may also be of a conical shape and may optionally include a barbed protrusion extending outwardly from the insert 13 on opposite sides of the insert and facing downward towards the wide end of the insert conical shape to act as anchors so that the insert 13 will not pull out during actuation or movement of said line or leader 9.

Both the weighted and the nonweighted insert 13 are installed into the lure's body 10 with the small end of the insert 13 facing upward so as to allow the conical shape of the insert 13 to hold the insert 13 from pulling out of the top of the lure body 10. The pass-through insert 13 has an inverted conical flute on either the top and or the bottom of said insert 13 that are positioned on a 90 degree, 45 degree or other angles from center so as to allow the fishing line leader 9 to pass through the insert 13 with minimal line drag or resistance when using different size line or leader material, i.e. 10, 20, 30, 40, 50 pound test, but to also act as a funnelling channel to keep the leader line 9 from binding with the plastic type body material 10.

The insert 13 may optionally include a special shaped hook insert 8 that when installed into the weighted insert 13 provides an additional fish hooking function of said lure.

The device preferably also includes a cavity or belly pouch 24 within the body 10 of the lure 1 to accept a capsule or other device that is designed to illuminate the body for nighttime or deep water applications of said lure and/or a rattle-type capsule that makes a rattle-type noise for additional attracting feature. The cavity or belly pouch 24 is also designed to accept a fresh scent material either man-made or natural for the utilization of the scent or smell of live bait to create a more realistic or natural artificial bait to further attract game fish. Such man-made attractant chemicals are commercially available.

The device preferably also includes a leader line weight 14 made of a nonferrous metal such as lead that is crimped onto the leader line in advance of the line passing through the head insert 13 so as to stabilize the leader line to create a more responsive line action for deep water applications.

The device may also include an in-line, preferably magnetically operated, cork type float 17 (though only shown in FIG. 1, this float 17 can be used with any of the lures of the present invention) that is attached in front of the lure's leader line weight to create a double bouncing effect so as to further accentuate the tail and leg movements of the said lure. The magnetic cork is made, for example, of a Styrofoam or plastic buoyant type material body 17 that has a hole through the center 18 that allows for the insertion of a plastic and/or metal actuator rod 20 that has a bore through the center of said rod 20 so that the fishing line or leader 9 may pass through said rod 20 so that the user may easily adjust the lure's line depth for various fishing applications. The plastic or metal rod 20 can be flared on both ends so as to contain or keep the installed magnets 22 from sliding off of the rod 20, but to also act as a guide for the line stop 19 that allows for the easy adjustment of the fishing lure depth. The rod 20 and the linestop 19 may be made of various plastic and/or metal material.

The opposite opposing ceramic magnets 22 are installed onto the actuator rod 20 through a hole in the center of said magnet 22 and are held in place at the desired distance from the opposite opposing ceramic magnet 15 that is affixed to the top and or bottom of said cork body 17 by limiting the length of said actuating rod 20, i.e. 4″, 5″, 6″, et cetera and then flaring the end 16 of said rod 20 to act as a retainer for said magnet 22. The opposite opposing ceramic magnets 15 are installed on the cork bottom 17 and the actuator rod 20 in opposing magnetic field position, i.e. North facing South on either side of the cork body 17, so as to create an opposing force when the cork body 17 movement is pushed towards or against the movement of the said rod 20 to create the desired up and down action helpful to simulate the minute action of a living bait shrimp, fish or crawfish, but to also push the rod magnet 22 up against the flared section 16 of the actuator rod 20 so as to create the opposite opposing magnetic force that creates said actuator rod 20 movement.

The magnet cork device 17 is also designed to create the slapping or clicking noise that a live shrimp or bait makes when the tail section of the live bait makes contact with its body section. The clicking noise is produced by the yanking of the fishing line 9 so as to pull the South facing magnet 22 on the bottom of actuator rod 20 up to make contact with the North facing magnet 15 that is attached to the bottom of the cork body 20 so that the clicking noise is produced at the exact time that the fishing line leader 9 pulls or actuates the tail section 5 of the body section 10 of the described fishing lure.

The magnets 22 and 15 on the top side of the magnetic cork may optionally be coated with a plastic type material (such as a rubber type material, e.g.) so as not to allow a double clicking noise that may be produced when the force of the line action that actuates the said clicking noise is greater than the force necessary to engage a single clicking noise.

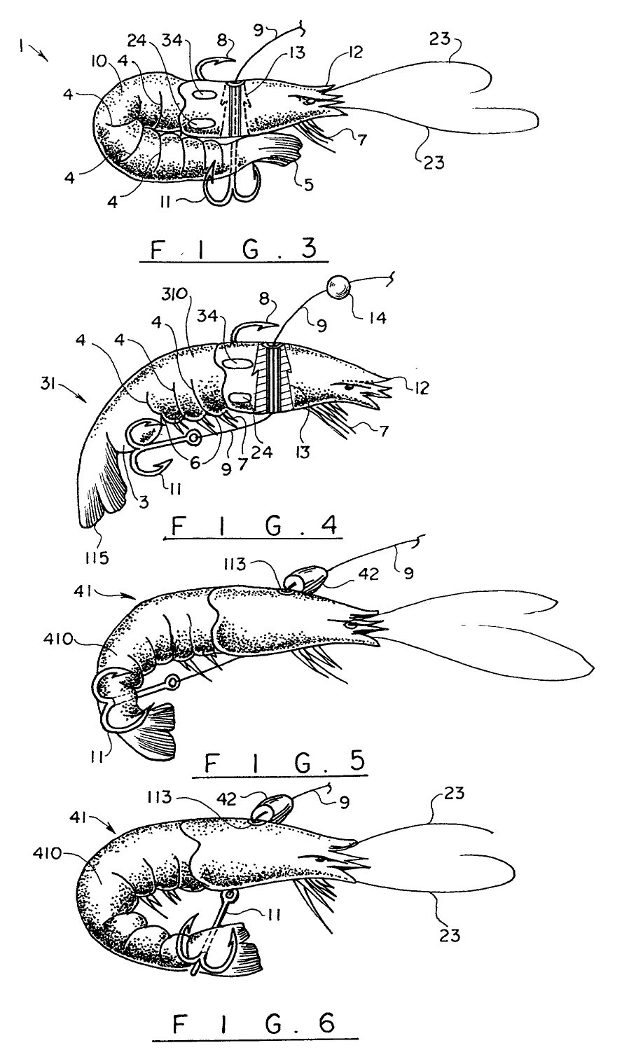

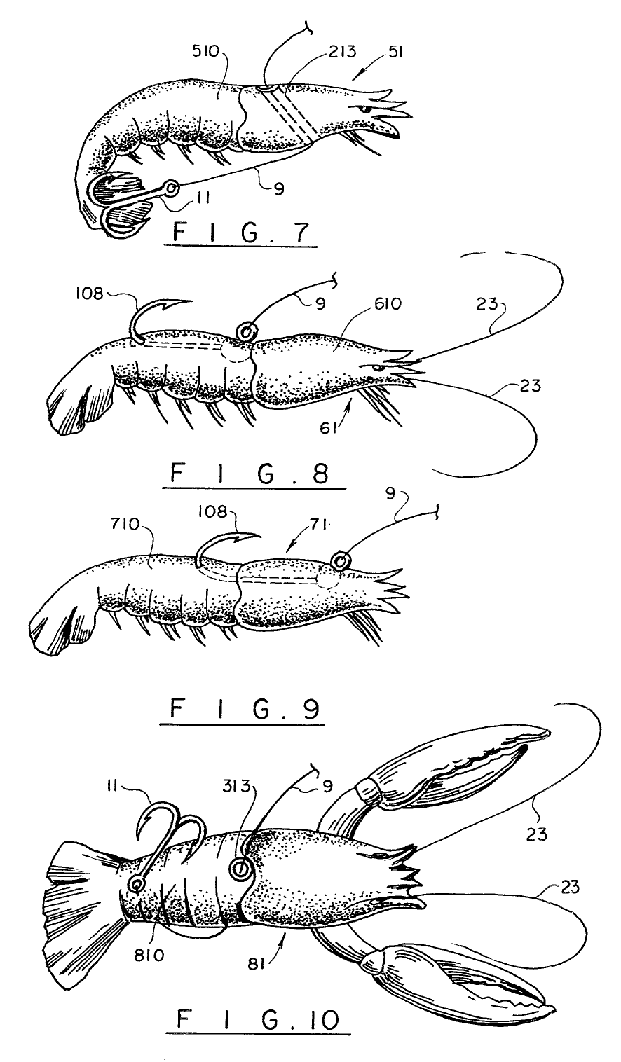

Though the hooks are sometimes shown on the top of the shrimp (as in FIGS. 1-3) and sometimes shown below the shrimp (as in FIGS. 4 and 7), generally it appears that the lure will catch fish better when the hooks are on the top of the shrimp.

It is a further object of the present invention to provide a new and improved fishing lure which optionally utilizes crushed glass as a reflective radiance 34 for the body section so as to further enhance the attractiveness of said lure but moreover to simulate the true reflective properties of a bait in the natural environment to which its intended use is proposed. In this respect, the prior art and claims as in U.S. Pat. No. 5,787,634, shows that those skilled in the art of lure making use commercially available aluminum or coated glittered flakes to create additional attraction for attracting fish to a bait but this reflective material does not simulate the natural reflective properties of underwater creatures.

Lure 31, shown in FIG. 4, is similar to lure 1. It differs primarily in the tail section 115 .

The tail section 115 of the lure 31 shown in FIG. 4 has a protrusion 3 formed on the underside of the body section 10 that extends outwardly from said section so as to accept the insertion of a fishing hook 11 or hooks to which the fishing line 9 that passes through the passthrough insert 13 is attached to create the mechanism for the movement of said tail 115 to simulate the natural movement of said lure by the movement of the surface cork and/or the action of a fishing rod.

The far end of the body section 310, tail 115, preferably has a specially designed cupped tip to create additional or maximum water movement so that the lure moves with the slightest actuation of the cork or line by either the wave movement and/or by the additional movement or action of the tip of a fishing rod.

Lure 41, shown in FIGS. 5 and 6, includes a body 410 and a tube 113, which can be a simple cylinder similar to tube 213 (shown in FIG. 7) and secured in any appropriate fashion in body 410. A weight 42 helps to balance lure 41 so that it travels relatively horizontal in the water (preferably, all of the lures of the present invention are constructed or weighted so that they travel relatively horizontal in the water).

Lure 51 (FIG. 7) includes a body 51 with a tube 213 which is slanted from back on the top to front on the bottom.

Lure 61 (FIG. 8) includes a body 610 and a hook 108 which preferably has a weight thereon to allow lure 61 to travel relatively horizontal in the water. Lure 61 does not include a tube means, so it does not close as do lures 1, 31, 41, 51, 81, but it can be attached to cork 17.

Lure 71 (FIG. 9) is similar to lure 61, but includes a body 710 with a head without eyes and without whiskers 23.

Lures 1, 31, 41, 51, 61, 71 preferably track like a real shrimp, and dive for the bottom when one stops reeling them in. This can be achieved by using weights to balance the lures so that they travel relatively horizontal in the water.

All lures of the present invention can be made with out without (but preferably with) whiskers 23. Whiskers 23 can advantageously be made of a holographic fly fiber, such as that available as part no. 4012 from Hedron, Inc., of 402 N. Main, Stillwater, Minn. 55082, US.

Lure 81 includes a crawfish-shaped body 810 with a tube 313. The line 9 can pass through the tail through a hole just large enough for the line, for example. In fact, this method of attaching the hook 11 to the tail could be used with the other lures 1, 31, 41, 51 as well (as it presents more of the hook 11 to the fish which attacks the lure).

While it is preferred to have an insert which acts as a tube means for allowing the line 9 to pass through the bait body, the insert could be omitted and the tube means could simply comprise an opening in the bait body through which the line 9 passes; however, this is not preferred, as there is a greater likelihood of frictional engagement of the line 9 and the bait body in that case.

Parts List:

The following is a list of parts and materials suitable for use in the present invention:

1 fishing lure of the preferred embodiment of the present invention

3 protrusion formed on the underside of the body section 310

4 cuts in the top portion of the lure

5 tail section

6 grooves or cavities in the underside of the body section 10

7 legs and tentacles

8 special shaped hook insert in weighted insert 13

9 fishing line or leader (monofilament or plastic-coated steel leader cable, for example)

10 body (a flexible plastic type material, e.g., flexible plastisol) of lure 1

11 fishing hook (treble, double or single, e.g.)

12 forward fins of a shrimp

13 head insert (tube means)

14 leader line weight (nonferrous metal such as lead)

15 magnet

16 flaredend ofrod20

17 fishing cork

18 hole through center of cork 17

19 line stop

20 actuator rod

22 magnet

23 whiskers of shrimp body 10

24 cavity or belly pouch within the body of the lure

34 reflective radiance for the body section (e.g., crushed glass)

31 fishing lure of a second embodiment of the present invention

41 fishing lure of a third embodiment of the present invention

42 weight of lure 41

51 fishing lure of a fourth embodiment of the present invention

61 fishing lure of a fifth embodiment of the present invention

71 fishing lure of a sixth embodiment of the present invention

81 fishing lure of a seventh embodiment of the present invention

113 head insert (tube means) of lure 41

115 tail section of lure 31

213 head insert (tube means) of lure 51

313 insert (tube means) of lure 81

310 body (a flexible plastic type material, e.g., flexible plastisol) of lure 31

410 body (a flexible plastic type material, e.g., flexible plastisol) of lure 41

510 body (a flexible plastic type material, e.g., flexible plastisol) of lure 51

610 body (a flexible plastic type material, e.g., flexible plastisol) of lure 61

710 body (a flexible plastic type material, e.g., flexible plastisol) of lure 71

810 body (a flexible plastic type material, e.g., flexible plastisol) of lure 81

The present invention could also be used with artificial rock shrimp, river shrimp, opossum shrimp, mantis shrimp, spiny rock lobster, skeleton shrimp, fairy shrimp, crawfish, American lobster, barbed shrimp, shop shrimp, coral shrimp, blue crab, rock crab, fiddler crab, ghost crab, squid, and flounder.

Exemplary lengths of the shrimp body lures are ¼″ to 20″, and preferably 1″ to 12″.

All measurements disclosed herein are at standard temperature and pressure, at sea level on Earth, unless indicated otherwise. All materials used or intended to be used in a human being are biocompatible, unless indicated otherwise.

The foregoing embodiments are presented by way of example only; the scope of the present invention is to be limited only by the following claims.

1. A fishing lure comprising:
a. an artificial shrimp body having a tail; and
b. a tube means in the artificial shrimp body for allowing a line to pass from the tail of the artificial shrimp body through the tube means.

2. A fishing lure comprising:
an artificial shrimp body having a tail;
a tube means in the artificial shrimp body;
a line passing from the tail of the artificial shrimp body through the tube means.

3. The fishing lure of claim 2, further comprising sound-making means for making a sound similar to the slapping or clicking noise that a live shrimp makes when the tail section of the live shrimp makes contact with its body section.

4. The fishing lure of claim 3, wherein the sound-making means comprises a float having a magnet thereon.

5. The fishing lure of claim 3, wherein the sound-making means comprises:
a float means slidingly received on a rod means;
a first magnet attached to the float means;
a second magnet attached to the rod means, the first and second magnets being aligned such that they repel one another.

6. A fishing lure comprising:
an artificial shrimp body having a tail; and
a tube in the artificial shrimp body for allowing a line to pass from the tail of the artificial shrimp body through the tube.

7. A fishing lure comprising:
an artificial shrimp body having a tail;
a tube in the artificial shrimp body;
a line passing from the tail of the artificial shrimp body through the tube.

8. Apparatus for making a sound similar to the slapping or clicking noise that a live shrimp makes when the tail section of the live shrimp makes contact with its body section, comprising:
a float means slidingly received on a rod means;
a first magnet attached to the float means;
a second magnet attached to the rod means, the first and second magnets being aligned such that they repel one another.

9. Apparatus for making a sound similar to the slapping or clicking noise that a live shrimp makes when the tail section of the live shrimp makes contact with its body section, comprising:
a float slidingly received on a rod;
a first magnet attached to the float;
a second magnet attached to the rod, the first and second magnets being aligned such that they repel one another.

10. A fishing lure comprising:
an artificial shrimp body having a tail; and
an opening in the artificial shrimp body for allowing a line to pass from the tail of the artificial shrimp body through the opening.

11. A fishing lure comprising:
an artificial shrimp body having a tail;
an opening in the artificial shrimp body;
a line passing from the tail of the artificial shrimp body through the opening.

12. Apparatus including:
a fishing lure comprising:
an artificial shrimp body having a tail;
a tube means in the artificial shrimp body; and
a line passing from the tail of the artificial shrimp body through the tube means; and
a sound-making means for making a sound similar to the slapping or clicking noise that a live shrimp makes when the tail section of the live shrimp makes contact with its body section.

13. The apparatus of claim 12, wherein the sound-making means comprises a float having a magnet thereon.

14. The apparatus of claim 12, wherein the sound-making means comprises:
a float means slidingly received on a rod means;
a first magnet attached to the float means;
a second magnet attached to the rod means, the first and second magnets being aligned such that they repel one another.

15. Apparatus including:
a fishing lure comprising:
an artificial shrimp body having a tail;
a tube means in the artificial shrimp body; and
a line passing from the tail of the artificial shrimp body through the tube means; and
a sound-making means for making a sound similar to the slapping or clicking noise that a live shrimp makes when the tail section of the live shrimp makes contact with its body section, comprising:
a float means slidingly received on a rod means;
a first magnet attached to the float means;
a second magnet attached to the rod means, the first and second magnets being aligned such that they repel one another.

16. A fishing lure comprising:
an artificial bait body having a tail; and
a tube means in the artificial bait body for allowing a line to pass from the tail of the artificial bait body through the tube means.

17. A fishing lure comprising:
an artificial bait body having a tail;
a tube means in the artificial bait body;
a line passing from the tail of the artificial bait body through the tube means.

18. A fishing lure comprising:
an artificial bait body having a tail; and
an opening in the artificial bait body for allowing a line to pass from the tail of the artificial bait body through the opening.

19. A fishing lure comprising:
an artificial bait body having a tail;
an opening in the artificial bait body;
a line passing from the tail of the artificial bait body through the opening.

20. A fishing lure comprising:
an artificial bait body having a head and a tail;
an opening in the artificial bait body positioned forward of the tail, generally in between the head and the tail;
a flexible fishing line or leader having first and second ends, a first end being attached to the tail of the artificial bait body, the line or leader passing through the opening, wherein:
the second end of the line or leader is connected to a fishing reel or to a length of fishing line wound upon the reel.

21. The fishing lure of claim 20, wherein:
the line is a section of leader that has first and second ends, a first end attached to the tail, and the second end defining a point of attachment for attaching a user's rod/reel thereto.

22. The fishing lure of any one of claims 1-7 or 10-21, further comprising a hook attached to the lure body.

23. The fishing lure of any one of claims 1-7 or 10-21, further comprising a hook attached to the line.

24. A method of fishing using the lure of any prior claim to catch fish.

25. The invention(s) substantially as shown and/or described herein.
